(19) United States
(12) Patent Application Publication
(10) Pub. No.: US 2021/0150418 A1
(43) Pub. Date: May 20, 2021

(54) System and Method for Managing Parking Queries

(71) Applicant: SOLUTIONS B-CITI INC., Longueuil (CA)

(72) Inventors: Amine Amrouss, Montreal (CA); Patrick Munroe, Montreal (CA); Vivianne Gravel, Longueuil (CA)

(21) Appl. No.: 16/630,823

(22) PCT Filed: Jul. 12, 2018
(86) PCT No.: PCT/CA2018/050853

§ 371 Date: Jan. 13, 2020

Related U.S. Application Data
(60) Provisional application No. 62/532,636, filed on Jul. 14, 2017.

(51) Int. Cl. G06Q 10/02; G08G 1/14; G06Q 10/10; G06F 16/2457

(52) U.S. Cl. CPC G06Q 10/02; G08G 1/141; G06Q 50/01; G06Q 10/1095; G06F 16/24575; G08G 1/145

(57) ABSTRACT

A method and system for managing parking queries includes receiving an electronic parking query associated with a querying user, the query indicating a parking location and a parking date, clustering from user-generated event data for a plurality of non-querying users a subset of relevant user-generated event entries corresponding to the parking location and the parking date, and determining a set of parking occupancy parameters for the electronic parking query based on one or more event attributes of the relevant user-generated event entries of the subset. A parking reservation invitation may be generated based on the set of parking occupancy parameters. User-generated event data may include electronic scheduling entries and/or social media events. Parking occupancy parameters can also be augmented based on one or more additional entries.

### RELATED PATENT APPLICATION

The present application claims priority from U.S. provisional patent application No. 62/532,636, filed Jul. 14, 2017 and entitled “SYSTEM AND METHOD FOR MANAGING PARKING QUERIES”, the disclosure of which is hereby incorporated by reference in its entirety.

### TECHNICAL FIELD

The present disclosure generally relates to a system and method for managing parking queries, and more particularly relates to determining parking occupancy parameters based on user-generated event data.

### BACKGROUND

Finding an unoccupied parking space can often be a time-consuming task, especially in downtown areas of large cities. This is due both to a limited number of allocated parking spaces in a given area and to the lack of information about unoccupied parking spaces allocated to drivers. Additionally, a driver may keep circling an area to find an unoccupied parking space, which contributes to an increase in traffic congestion. The negative effects of such behavior include increased noise, increased fuel consumption, and increased harmful emissions. The search for an unoccupied parking space can also increase the driver's stress level and therefore poses a road safety risk.

Currently available solutions include parking guidance systems, crowd-sharing of parking information, and reservation systems. Parking guidance systems inform drivers about unoccupied parking spots using display boards placed on the roadside. Display boards guide the drivers while they are currently on the road network. This can result in higher travel times because a driver must follow the guidance provided by the display boards. Making parking occupancy information available ahead of time can reduce the travel time for drivers. For example, a reservation system can be used to reserve an unoccupied parking space for a driver. However, reserving a parking space may result in unoptimized use of allocated parking spaces because a reserved parking space may be left unoccupied for long durations of time. Such reservation systems may be more suitable for off-street parking than on-street parking.

Crowd-sharing systems are based on information about unoccupied parking space reported by other drivers. The success of this approach relies on the participation of the drivers and on the quality of information they report. Therefore, drivers need to be incentivized to report the information.

More reliable information can be obtained through a network of parking space occupancy sensors and wireless communication devices. However, implementation and maintenance of such a network is costly.

### SUMMARY

According to one aspect, there is provided a method for managing parking queries. The method includes receiving an electronic parking query associated with a querying user, the query indicating a parking location and a parking date, clustering from user-generated event data for a plurality of non-querying users a subset of relevant user-generated event entries corresponding to the parking location and the parking date, and determining a set of parking occupancy parameters for the electronic parking query based on one or more event attributes of the relevant user-generated event entries of the subset.

According to another aspect, there is provided a system for managing parking queries. The system includes a memory for storing a plurality of instructions and a processor coupled to the memory. The processor is configured for receiving an electronic parking query associated with a querying user, the query indicating a parking location and a parking date, clustering from user-generated event data for a plurality of non-querying users a subset of relevant user-generated event entries corresponding to the parking location and the parking date, and determining a set of parking occupancy parameters for the electronic parking query based on one or more event attributes of the relevant user-generated event entries of the subset.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates a schematic diagram of the operative modules of a parking query management system according to one example embodiment;

FIG. 2 illustrates a flowchart showing the operational steps of a method for managing a parking query according to one example embodiment; and

FIG. 3 illustrates a flowchart showing the operational steps of a method for determining the set of parking occupancy parameters in response to a received electronic parking query in accordance with one example embodiment.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

“Allocated parking space” herein refers to a parking space that has been, or that will be allocated, so that it can be occupied by a vehicle. An allocated parking space may be unoccupied by a vehicle, occupied by a vehicle, or reserved.

“Occupied parking space” herein refers to an allocated parking space that is currently occupied by a vehicle or will be occupied in the future at a specific future date. Accordingly, the occupied parking space is not available to be occupied by another vehicle.

“Unoccupied parking space” herein refers to an allocated parking space that is not currently occupied by a vehicle or will be unoccupied in the future at a specific future date. Accordingly, the unoccupied parking space is available to be occupied by a vehicle.

Broadly described, systems and methods described herein cluster user-generated event data (ex: electronic scheduling entries, social media events, social media posts) that are relevant to a user seeking an unoccupied parking space. The user-generated event data is used to determine a set of parking occupancy parameters relevant to the user. For example, the set of parking occupancy parameters can indicate where and when parking spaces are unoccupied, recommend an area to look for unoccupied parking spaces, determine a pricing for unoccupied parking spaces, and generate an invitation to the user to reserve an unoccupied parking space.

One or more systems and methods described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, wearable device, tablet device, smart display devices (ex: Smart TVs), set-top box, video game console, portable video game devices, or virtual reality devices.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein. In some embodiments, the systems may be embedded within an operating system running on the programmable computer.

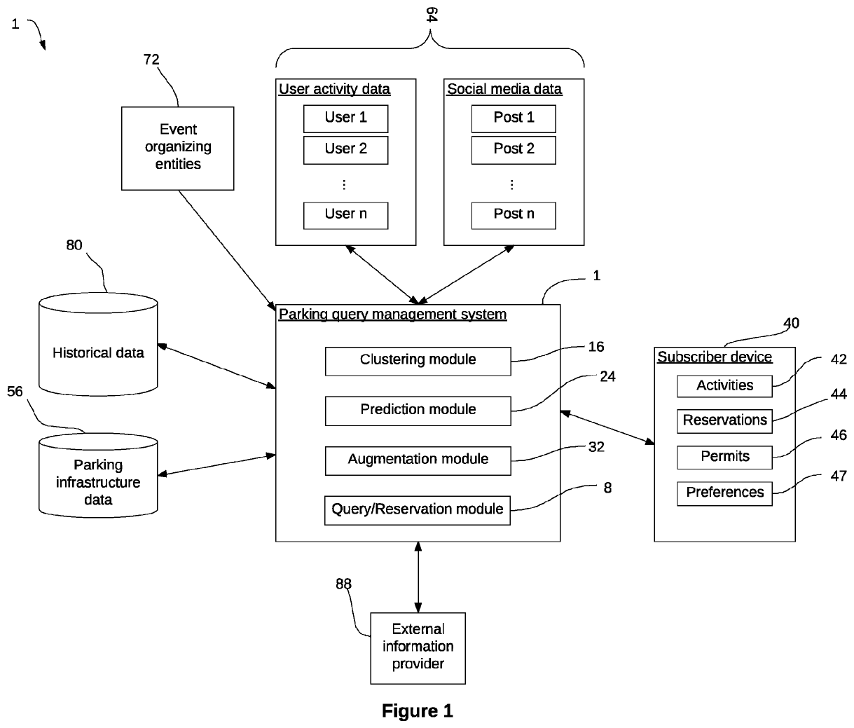

Referring now to FIG. 1, therein illustrated is a schematic diagram of the operative module of a parking query management system 1 according to one example embodiment. The parking query management system 1 may be implemented as a server-based or cloud-based platform.

The parking query management system 1 described herein may be administered and made available for a given geographical region. For example, the parking query management system 1 can be integrated within a smart city system. Users of the parking query management system 1 can access features of the system 1 via an electronic portal having a user interface.

The parking query management system 1 includes a query/reservation module 8, a clustering module 16, a prediction module 24 and an augmentation module 32.

The query/reservation module 8 is operable to receive an electronic parking query associated with a given querying user. The querying user refers to a user that is subscribed to the parking query management system 1. Various information about the querying user can be made available to the parking query management system 1, such as planned events for the user, parking reservations made by the user (ex: past reservations, present reservations, and/or future reservations), user preferences, and/or parking permits paid by the querying user.

As illustrated in FIG. 1, the parking query management system 1 is in communication with an electronic device 40 (ex: smartphone, vehicle infotainment system, tablet, desktop/laptop, cloud-based data storage, etc.) associated with the querying user. The electronic device can store one or more planned events data entries 42, parking reservation entries 44, parking permit entries 46, and user preference entries 47. The planned event data entries can be events stored in an electronic scheduling system for the querying user (ex: Google Calendar, Outlook Calendar, etc.). Additionally, or alternatively, these data entries 42, 44, 46 and 47 can be stored in a cloud-based system and/or be associated with a user account belonging to the subscribed user. User preferences for the subscribed user may include favorited parking facility, preferred route, distance versus cost, etc.

The electronic parking query can be generated at the subscriber electronic device 40 and transmitted to the parking query management system 1, whereby the electronic parking query is received by the query/reservation module 8. For example, a computer program, such as a mobile app, is executed at the subscriber electronic device 40 to generate the parking query.

The electronic parking query can also be generated by the query/reservation module 8. Information pertaining to the querying user can be received at the parking query management system 1 and the query/reservation module 8 can generate the parking query based on this information. It will be understood that receiving a parking query at the query/reservation module 8 includes the generation of the parking query by the module 8.

The electronic parking query can be a user-generated query. The human user can interact with the electronic device 40 to manually enter the information relevant for generating the parking query. The user interface can be a graphical user interface, a speech recognition system, a phone call, etc.

The electronic parking query can be an automatically generated query. The query can be automatically generated based on stored information (ex: data entries 42, 44, 46, 47) for the querying user. For example, a planned event entry 42 stored in an electronic scheduling system for the querying user can suggest that a parking query should be made. This can be validated if past reservation entries 44 indicate that the user has previously reserved a parking space at a location corresponding to that planned event. Other pertinent information may include identity, gender, age, family or friendship links with other users, predefined parking preferences.

The query can also be automatically generated based on other properties for the querying user, such as current geo-location of the electronic device 40, current traveling speed of the electronic device 40, sensed eye or head movement of the user within a vehicle. These properties can be used to validate a query generated based on stored information about the querying user. For example, if there is a planned event entry 42 for a given time and location and it is detected that the user's vehicle is located at that time and at the location, then a parking query is automatically generated.

The electronic parking query that is generated indicates at least a parking location (an area where the user wishes to park) and a parking date (a date and time of day when the user wishes to park). The parking date can indicate that a parking space is immediately required. Alternatively, the parking date can indicate that a parking space will be required at a future parking date. Additional properties can also be specified in the electronic parking query, such as the duration of the parking, where the user has parking permits, preference for a specific parking facility, request for a valet service, presence of electric recharging stations, etc. The additional properties may be manually entered by a user. Alternatively, the additional properties can be determined based on stored information for the querying user.

The parking location can indicate a destination where a user has planned an event. For example, the parking location can be defined by a specific address. The parking location can also correspond to a geographical area surrounding the destination (ex: within a particular radius of the destination, a number of blocks of the destination, a neighborhood of the destination).

Alternatively, the parking location may include a plurality of geographical areas. The areas can be ones that are in proximity of the user's destination. Providing a plurality of geographical areas can allow finding more choices of unoccupied parking spaces in response to the parking query. Additionally, where a plurality of parking queries are received, the parking query management system 1 can manage parking loads amongst the areas.

The parking date can be a future parking date. That is, at the time the parking query is generated, the query may be for parking at a date that is in the future relative to the generated query. The parking date can be at least one hour in the future. Alternatively, the parking date can be at least one day in the future. For example, parking queries for a future parking date can be generated ahead of time based on planned event entries 42 for events occurring in the future.

The parking query can also define user preferences, such as favorited parking facilities, types of parking lots, on-street versus off-street, permits subscribed to, etc.

In one example embodiment, the electronic parking query may be generated by a parking facility operator. Accordingly, the querying user is the parking facility operator. For example, the electronic parking query is generated in order for the parking facility operator to assess the parking demand for a given parking location and parking date. The parking location can correspond to a particular parking facility operated by the operator. The parking location can indicate the parking facility itself, or indicate a geographical area surrounding the parking facility.

The prediction module 24 of the parking query management system 1 is operable to determine a set of parking occupancy parameters in response to the received electronic parking query. The set of parking occupancy parameters represent information that is useful for guiding the querying user to an unoccupied parking space. The set of parking occupancy parameters can also allow the querying user to make a reservation of an unoccupied parking space. The set of parking occupancy parameters can indicate one or more of the following: expected demand for parking for a given area corresponding to the parking location, specific location of unoccupied parking spaces, price for the unoccupied parking spaces, time of parking requests, stay duration, occupancy rate, number of unoccupied spaces, duration that one or more parking spaces are unoccupied, and/or expected demographics (sex, age, profession, etc.) of users that will be parking.

In the case of a parking query generated by a parking facility operator, the set of parking occupancy parameters is useful for the operator to set appropriate pricing for the parking location and date and/or to assess staffing needs for that location and date. For example, where parking demand is likely to be high for that parking facility and/or the area surrounding the parking facility for a given date, then the operator can increase parking prices and/or increase staffing on that date.

Continuing with FIG. 1, the parking query management system 1 is in communication with a parking infrastructure database 56 storing data relevant to parking infrastructure. The parking infrastructure data generally relates to how parking spaces are allocated for the region covered by the parking query management system 1. For example, parking infrastructure database may include location of private parking lots, location of public parking lots, opening times of private parking lots, opening times of public parking lots, number of allocated parking spaces in the parking lots, location and number of on-street metered spaces, location and number of non-metered spaces, parking regulations (ex: when on-street parking is permitted), permits required for on-street parking, etc. The parking infrastructure data can also indicate time-sensitive information, such as parking spaces that are occupied and/or reserved or when parking spaces will be occupied and/or reserved in the future.

In response to receiving the electronic parking query, the prediction module 24 can retrieve parking infrastructure data from the parking infrastructure database 56 that corresponds to the parking location and the parking date indicated in the electronic parking query. The prediction module 24 can further determine the set of parking occupancy parameters based on the retrieved parking infrastructure data.

The prediction module 24 can also evaluate other received parking queries that have a parking location and a parking date that correspond to a given electronic parking query. The parking occupancy parameters can also take into account these other received parking queries.

Continuing with FIG. 1, the parking query management system 1 can further receive user-generated event data 64 for a plurality of non-querying users. Non-querying users herein refer to any user other than the querying user that generated the current electronic parking query. The non-querying users can include other users subscribed to the parking query management system 1. The non-querying users can also include other users that are not subscribed to the parking query management system 1.

The user-generated event data 64 for the non-querying users herein refers to data of event participation by the non-querying users that can provide an indicator of demand for parking spaces. The user-generated event data refers to data other than electronic queries received at the parking query management system 1.

The user-generated event data 64 can include user-generated event electronic entries 64 for the non-querying users. A user-generated event entry 64 specifically indicates an event that the non-querying user is currently participating in or has planned to participate in at a future date.

The user-generated electronic event entries 64 can be entries made in electronic scheduling systems (ex: Google Calendar, Outlook Calendar, etc.) of each of the non-querying users. The non-querying users can choose to share this information with the parking query management system 1. The electronic scheduling entries may include the location of the event, the date of the event and the duration of the event. The electronic scheduling entry may also provide an indication of whether the non-querying user is likely to require a parking space for that event. For example, an event entry for a given non-query user can be:
Location: 5 Civic Centre road;
Date: Thursday, 7 PM;
Description: “Timmy's hockey game”
   The above event entry indicates a higher likelihood of requiring a parking space because a vehicle is required to carry the hockey equipment.

The electronic scheduling system can be a system that is specific for scheduling. Alternatively, the electronic scheduling system can be a subsystem of a greater system in which electronic scheduling is only part of that system. For example, various event booking systems (ex: ticket reservation system) include an electronic scheduling subsystem.

The user-generated electronic event entries 64 can be event entries made on a social media platform, such as a Facebook event or the like. The non-querying users can choose to share the social media event information with the parking query management system 1. It will be appreciated that event entries on a social media platform typically specify an event location and an event date. Other event attributes can also be included, such as duration of the event. The social media platform event can also include a feature that specifically indicates whether a user, such as non-querying user, will be attending or not attending the event.

The user-generated electronic event entries 64 can be social media posts by non-querying users that contain indicators of likelihood of users participating at a given event. For example, from a plurality of social media posts, a subset of posts that pertain to event participation can be extracted. Event information, such as event location, event date, and event duration can be further extracted from the subset of posts. Social media posts are typically publicly available. Event information may be extracted from the text of the posts or from other data in the post, such as metadata, hashtags, tags, links, embedded video, embedded image, etc. For example, a social post may have the following content:
“Excited to get a new shoulder tattoo on Sunday at my favorite place @ExtremeParlor #GettingInked”.

The above social media post can indicate an event date (Sunday), location (location of Extreme Parlor from tag @ExtremeParlor) and duration (typical time to obtain a new shoulder tattoo from text “shoulder” and hashtag “#GettingInked”).

The clustering module 16 is operable to receive the user-generated electronic event entries 64 extracted from electronic scheduling systems, social media events and/or social media posts for the plurality of non-querying users and to cluster the event entries by event location and an event date. Accordingly, entries for events that are likely to occur at a same location and/or on a same date are clustered together, which can be used to determine demand for parking spaces for that given location and/or date. The prediction module 24 is operable to determine the set of parking occupancy parameters based on the user-generated electronic event entries retrieved from electronic schedule systems of the non-querying users.

For example, in response to a given received electronic parking query, a subset of user-generated event entries 64 having event locations and event dates that substantially correspond to the parking location and the parking date of the electronic parking query are retrieved by the clustering module 16. This subset of user-generated event entries is considered as being relevant to the given electronic parking query. The prediction module 24 further determines the parking occupancy parameters based on retrieved parking infrastructure data corresponding to the parking location and the parking date. The subset of relevant user-generated event entries 64 can be an indicator of demand for parking spaces at the given location and date while the parking infrastructure data can be an indicator of supply of allocated parking spaces for that location and date.

In one example embodiment, user-generated event entries for the user that generated the electronic parking query are analyzed in conjunction with user-generated event entries for the non-querying users to determine the parking occupancy parameters.

Continuing with FIG. 1, the parking query management system 1 may be in communication with one or more event organizing entities 72. The organized event entities herein refer to entities that organize large-scale events in a professional manner. The large-scale events often have a high number of participants. The location and date of such events are also determined ahead of time. Examples of organized event entities include sporting event organizers, entertainment event organizers (ex: concerts, movies, etc.), government/municipal bodies (ex: parade, music festival), transportation services (ex: flight times, bus times, train times), etc.

The parking query management system 1 can receive information pertaining to the events organized by the event organizing entities 72 in the form of organized event data entries. These entries each include an event location and an event date. Additional information can also be included, such as duration, expected number of participants, and type of participants. For example, in the case of an airport, business-class passengers are more likely to use a parking space. Similarly, passengers going to a far-away destination are more likely to use long-term parking. A high number of flights within a short period of time can be correlated with higher parking demand.

The organized event data entries are received at an augmentation module 32 of the parking query management system 1. In response to an electronic parking query for a given parking location and a given parking date, the augmentation module 32 extracts organized event data entries having an event location and an event date corresponding to the parking location and the parking date. The extracted organized event data entries are further used to determine the parking occupancy parameters. Where parking occupancy parameters have already been determined, the extracted organized event data entries can be used to augment the parking occupancy parameters. The augmentation can be carried out by the augmentation module 32.

Continuing with FIG. 1, the parking query management system 1 may be in communication with a historical parking-related database 80. The historical parking-related database 80 stores parking-related data that can be used to predict future demand for parking spaces. Historical parking-related data may include arrival times of parking queries, parking duration, historical occupancy rate, historical number of vacant spaces, and/or duration that a parking space is unoccupied.

The historical parking-related data is received at the augmentation module 32 of the parking query management system 1. In response to an electronic parking query for a given parking location and a given parking date, the augmentation module 32 extracts parking-related data pertaining to the parking location and the parking date of the query. The relevant historical parking-related data is further used to determine the parking occupancy parameters. Where parking occupancy parameters have already been determined, the extracted organized event data entries can be used to augment the parking occupancy parameters. The augmentation can be carried out by the augmentation module 32.

The parking query management system 1 may be in communication with an external information provider 88. The external information provider 88 provides non-parking related and non-event related data. However, this data can be useful in that it contains information regarding conditions that can influence demand for parking. For example, non-parking related/non-event data can include weather data. Other types of non-parking related/non-event data can include scheduled incidents (ex: road closure, construction) or unscheduled incidents (ex: road accident, terrorist attack).

The data from the external information provider 88 is received at the augmentation module 32 of the parking query management system 1. In response to an electronic parking query for a given parking location and a given parking date, the augmentation module 32 extracts non-parking related and non-event related data pertaining to the parking location and the parking date of the query. The relevant historical parking-related data is further used to determine the parking occupancy parameters. Where parking occupancy parameters have already been determined, the extracted organized event data entries can be used to augment the parking occupancy parameters. The augmentation can be carried out by the augmentation module 32.

The prediction module 24 and/or the augmentation module 32 can apply at least one of optimization techniques, statistical techniques and artificial intelligence techniques to determine the set of parking occupancy parameters in response to an electronic parking query.

In one example embodiment, an artificial intelligence parking occupancy model can be built. The parking occupancy model reflects a relationship between parking space occupancy in time and space relative to user-generated event data. The parking occupancy model can be built using historical parking-related data (ex: data relating to actual occupancy of spaces, or parking reservation history), historical event-related data (ex: historical user-generated event data, historical organized event data), historical parking infrastructure data and historical non-parking data and non-event data (ex: historical weather data, road closure data, etc.).

In one example embodiment, the parking occupancy model is trained once and is invariant over time. Accordingly, algorithms for determining parking occupancy parameters are not adjusted in real-time.

In an alternative example embodiment, the parking occupancy model is applied in real-time and prediction algorithms are updated based on newly received user-generated event data, organized event data, received parking queries, received parking reservations, non-parking/non-event data, and changes in parking infrastructure data. For example, the parking occupancy model can be updated by machine learning.

The parking occupancy model may include a plurality of sub-models. These sub-models may be updated together. Alternatively, some of the sub-models may be updated individually or in combination with a subset of other sub-models. Sub-models can correspond to clusters of data, such as temporal clusters (ex: for intervals of time, 1, 5, 30, 60 minutes), location-based clusters, or based on other attributes (ex: duration of parking, types of streets, parking regulation, population density, age of user, parking permits, types of vehicle [hybrid v. electric], etc.).

Clustering of data can be done in a static manner. Alternatively, clustering of data can evolve according to changes in parking occupancy patterns over time or for different locations.

The clustering of data can also be useful for dynamically adjusting the pricing of parking.

Continuing with FIG. 1, the query/reservation module 8 is further operable to generate an electronic parking reservation invitation based on the set of parking occupancy parameters that are determined. The electronic parking reservation invitation can be displayed on the user interface of a subscriber device 40.

The electronic parking reservation invitation may include suggestions of one or more unoccupied parking spaces and/or parking lots having unoccupied parking spaces. Pricing for the unoccupied parking spaces can also be indicated. The invitation can also include a prompt for a user to reserve an unoccupied parking space. A user can manually interact within the user interface of the electronic device 40 to reserve the unoccupied parking space.

An automatic reservation of an unoccupied parking space can be made in response to the electronic parking reservation. The automatic reservation can be made based on predefined user preferences and/or past behavior of the querying user.

The reservation of an unoccupied parking space indicated in the electronic parking reservation invitation can be a “soft” reservation or a “hard” reservation. A hard reservation corresponds to where the querying user commits to an unoccupied parking space (ex: by paying for the parking space) and the parking space is set aside for the user (i.e. the parking space cannot be occupied by someone else). A soft reservation corresponds to where the unoccupied parking space is hidden from view of subsequent querying users, but the parking space may still be occupied by another person. The soft reservation is useful where a hard reservation of the parking space cannot be made, such as for on-street parking.

In response to a user reserving an unoccupied parking space, a route from a current location to the reserved parking space can be calculated. An initial route can be determined using route navigation techniques commonly known in the art. The route can be further adjusted according to an optimization model taking into account received user-generated event data, organized event data, and non-parking/non-event data. Other information may also be taken into account within the model. Determination of the set of parking occupancy parameters can be carried out in combination with determination of the route.

Tracking of the querying user to detect arrival at a reserved parking can be carried out. This tracking may be implemented by the electronic device 40 (ex: using location-based services, in-vehicle components reporting engine turn-off, or based on user entry). A user can also be prompted on a user interface of the electronic device 40 to provide feedback regarding the quality of unoccupied parking space that was suggested/reserved and the route that was suggested. Additional feedback relating to nearby unoccupied parking spaces, en-route construction and ongoing events can also be given.

Within the tracking, additional tracking features can be implemented, such as notification of expiry of a reserved parking space and storing the location where the user's vehicle was parked. The tracking can also detect where the user is leaving or arriving at a “home” parking space. Leaving the home parking space will trigger a query to find another parking space. Detecting arrival at the home parking space will not trigger such a query.

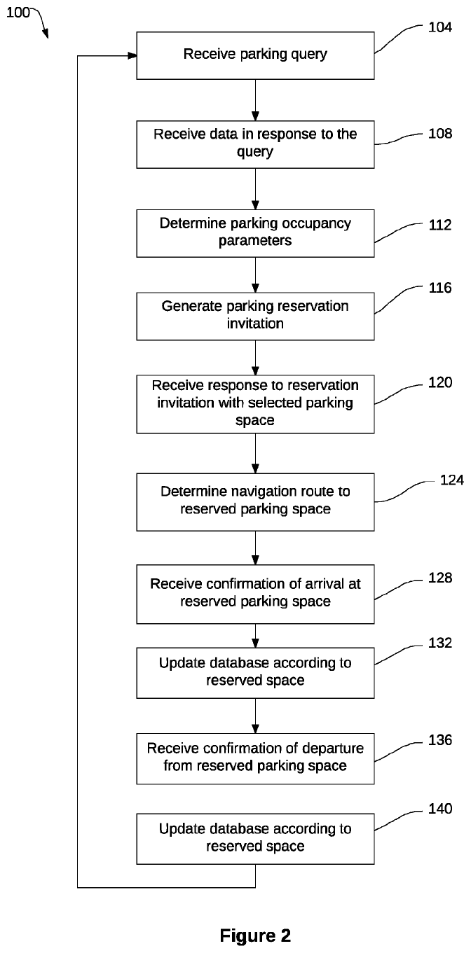

FIG. 2 illustrates a flowchart showing the operational steps of a method 100 for managing a parking query according to one example embodiment. Method 100 can be carried out in the parking query management system 1.

At step 104, an electronic parking query is received.

At step 108, one or more data entries pertinent to the parking query is received, such as parking infrastructure data, user-generated event data, historical parking-related data, organized event data, and non-parking/non-event data. Portions of the received data that corresponds to the parking location and the parking date of the parking query can be clustered.

At step 112, a set of parking occupancy parameters specific to the electronic parking query is determined based on the data entries received at step 108. The determination may be based on a pre-trained computer-implemented parking occupancy model.

At step 116, a parking reservation invitation is generated based on the set of parking occupancy parameters.

At step 120, a response to the reservation invitation is received. The response may indicate a parking space that the querying user wishes to reserve. The parking infrastructure database can be updated to reflect the reservation placed by the querying user.

At step 124, a navigation route from the querying user's current location to the reserved parking space is determined.

At step 128, a confirmation is received indicating that the querying user has arrived at the reserved parking space. Feedback regarding the reserved parking space and the navigation route can also be received.

At step 132, the parking infrastructure database can be updated to reflect that the reserved parking space is currently being occupied.

At step 136, a confirmation is received indicating that the querying user has left the reserved parking space.

At step 140, the parking infrastructure database can be updated to indicate that the given parking space is now currently unoccupied.

The method 100 further returns to step 104 to receive another electronic parking query for the querying user.

It will be appreciated that method 100 corresponds to one iteration of the parking query management method for a single received electronic parking query. Where a plurality of users are subscribed to the parking query management system 1, multiple iterations of method 100 can be carried out in parallel for a plurality of electronic parking queries from each of a plurality of querying users.

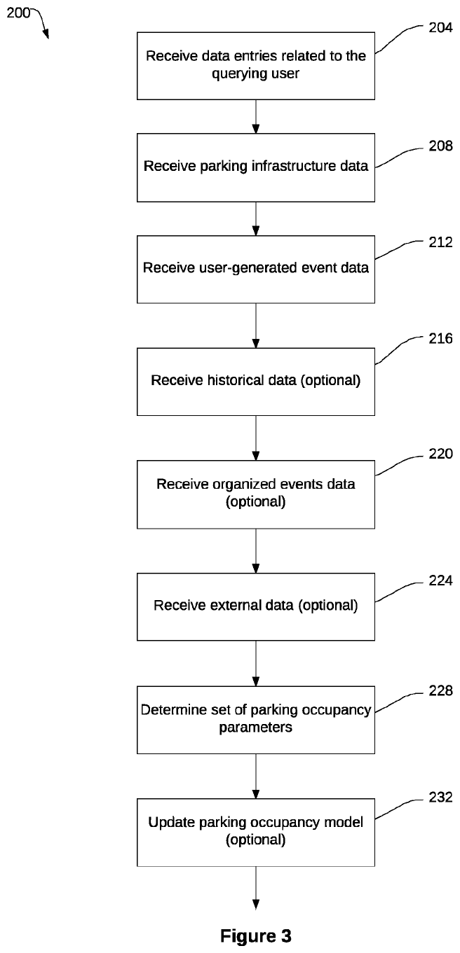

Referring now to FIG. 3, therein illustrated is a flowchart showing the operational steps of a method 200 for determining the set of parking occupancy parameters in response to a received electronic parking query in accordance with one example embodiment. The method 200 can correspond to steps 108 and 112 of method 100.

At step 204, various data entries pertaining to the querying user are received.

At step 208, parking infrastructure data relevant to the electronic parking query is received.

At step 212, user-generated event data for a plurality of non-querying users is received.

At step 216, historical data can optionally be received.

At step 220, organized event data can optionally be received.

At step 224, external non-parking/non-event data can optionally be received.

At step 228, the set of parking occupancy parameters specific to the received parking query is determined. This determination may be based on data received in steps 204 through step 224. This determination may be carried out using the parking occupancy model.

At step 232, the parking occupancy model may optionally be updated based on data received at steps 204 through step 224.

Various methods and systems described herein advantageously consider various sources of information that are useful for determining parking occupancy information in response to an electronic parking query. In addition to centralized sources of parking information, such as parking infrastructure data, organized events data and historical data, the parking query management system and method also clusters non-centralized data, such as user-generated event data to determine parking occupancy information.

Various methods and systems described herein may be applied in conjunction with autonomous vehicles. Information of a querying user may include both passenger and vehicle information. Vehicle information may include planned trips, drivetrain type (ex: electric, fossil fuel-based), type of vehicle (ex: passenger, commercial), etc.

Various methods and systems may be implemented in conjunction with various sharing systems, such as bike-share systems, car-share systems, delivery planning systems, fleet management systems, and the like. The systems can be used to predict parking occupancy, to reserve parking, or to manage a fleet of vehicles.

Various methods and systems may also be used for designing parking offerings (ex: parking permits), optimizing parking pricing, managing parking reservations based on information of querying users and user-generated event data.

Various methods and systems may be implemented by a public operator (ex: a municipal body for operating a smart city) or a private operator (ex: a corporate campus).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A method for managing parking queries, the method comprising:
receiving an electronic parking query associated with a querying user, the query indicating a parking location and a parking date;
clustering from user-generated event data for a plurality of non-querying users a subset of relevant user-generated event entries corresponding to the parking location and the parking date; and
determining a set of parking occupancy parameters for the electronic parking query based on one or more event attributes of the relevant user-generated event entries of the subset.

2. The method of claim 1, further comprising generating a parking reservation invitation based on the set of parking occupancy parameters.

3. The method of claim 1, further comprising receiving parking infrastructure data corresponding to the parking location and the parking date; and
wherein the set of parking occupancy parameters are determined based on the received parking infrastructure data.

4. The method of claim 1, wherein the user-generated event data for the plurality of non-querying users comprises electronic scheduling entries of the non-querying users; and
wherein electronic scheduling entries having an event location and an event date corresponding to the parking location and the parking date of the electronic parking query are clustered within the subset of relevant user-generated event entries.

5. The method of claim 1, wherein the user-generated event data for the plurality of non-querying users comprises social media events published on social media; and
wherein social media events having an event location and an event date corresponding to the parking location and the parking date of the electronic parking query are clustered within the subset of relevant user-generated event entries.

6. The method of claim 1, wherein the user-generated event data for the plurality of non-querying users comprises social media posts published on social media; and
wherein the method further comprises extracting from the social media posts, parking-related data corresponding to the parking location and the parking date of the electronic parking query, the parking-related data being clustered within the subset of relevant user-generated event entries.

7. The method of claim 1, further comprising:
receiving one or more organized event entries for organized events having an event location and an event date corresponding to the parking location and the parking date of the electronic parking query; and
augmenting the parking occupancy parameters based on one or more event attributes of the received organized event entries.

8. The method of claim 1, further comprising:
receiving one or more historical parking-related data corresponding to the parking location and the parking date of the electronic parking query; and
augmenting the parking occupancy parameters based on the received historical parking-related data.

9. The method of claim 1, further comprising:
receiving at least one non-parking/non-event data from an external source; and
augmenting the parking occupancy parameters based on the received non-parking/non-event data.

10. (canceled)

11. The method of claim 1, wherein the parking date is a future parking date relative to the electronic parking query.

12. (canceled)

13. (canceled)

14. The method of claim 1, wherein the querying user is a user seeking an unoccupied parking space;
wherein the parking location indicates a location where the user is seeking the unoccupied parking space; and
wherein the parking date indicates a time and day for which the user is seeking the unoccupied parking space.

15. The method of claim 1, wherein the querying user is a parking facility operator;
wherein the parking location indicates a location corresponding to a parking facility for which the user is seeking to assess demand for parking; and
wherein the parking date indicates a time and day for which the user is seeking to assess the demand for parking.

16. A system for managing parking queries, the system comprising:
a memory for storing a plurality of instructions;
a processor coupled to the memory, the processor configured for:
receiving an electronic parking query associated with a querying user, the query indicating a parking location and a parking date;
clustering from user-generated event data for a plurality of non-querying users a subset of relevant user-generated event entries corresponding to the parking location and the parking date; and
determining a set of parking occupancy parameters for the electronic parking query based on one or more event attributes of the relevant user-generated event entries of the subset.

17. The system of claim 16, wherein the processor is further configured for generating a parking reservation invitation based on the set of parking occupancy parameters.

18. The system of claim 16, wherein the processor is further configured for receiving parking infrastructure data corresponding to the parking location and the parking date; and
wherein the set of parking occupancy parameters are determined based on the received parking infrastructure data.

19. The system of claim 16, wherein the user-generated event data for the plurality of non-querying users comprises electronic scheduling entries of the non-querying users; and
wherein electronic scheduling entries having an event location and an event date corresponding to the parking location and the parking date of the electronic parking query are clustered within the subset of relevant user-generated event entries.

20. The system of claim 16, wherein the user-generated event data for the plurality of non-querying users comprises social media events published on social media; and
wherein social media events having an event location and an event date corresponding to the parking location and the parking date of the electronic parking query are clustered within the subset of relevant user-generated event entries.

21. The system of claim 16, wherein the user-generated event data for the plurality of non-querying users comprises social media posts published on social media; and
wherein the processor is further configured for extracting from the social media posts, parking-related data corresponding to the parking location and the parking date of the electronic parking query, the parking-related data being clustered within the subset of relevant user-generated event entries.

22. The system of claim 16, wherein the processor is further configured for:
receiving one or more organized event entries for organized events having an event location and an event date corresponding to the parking location and the parking date of the electronic parking query; and
augmenting the parking occupancy parameters based on one or more event attributes of the received organized event entries.

23. The system of claim 16, wherein the processor is further configured for:
receiving one or more historical parking-related data corresponding to the parking location and the parking date of the electronic parking query; and
augmenting the parking occupancy parameters based on the received historical parking-related data.

24. The system of claim 16, wherein the processor is further configured for:
receiving at least one non-parking/non-event data from an external source; and
augmenting the parking occupancy parameters based on the received non-parking/non-event data.

25. (canceled)

26. The system of claim 16, wherein the parking date is a future parking date relative to the electronic parking query.

27. (canceled)

28. (canceled)

29. The system of claim 16, wherein the querying user is a user seeking an unoccupied parking space;
wherein the parking location indicates a location where the user is seeking the unoccupied parking space; and
wherein the parking date indicates a time and day for which the user is seeking the unoccupied parking space.

30. The system of claim 16, wherein the querying user is a parking facility operator;
wherein the parking location indicates a location corresponding to a parking facility for which the user is seeking to assess demand for parking; and
wherein the parking date indicates a time and day for which the user is seeking to assess the demand for parking.
